(19) United States
(12) Patent Application Publication
(10) Pub. No.: US 2026/0364767 A1
(43) Pub. Date: Nov. 19, 2026

(54) Hand-Held Power Tool with Retaining Clip

(71) Applicant: Robert Bosch GmbH, Stuttgart (DE)

(72) Inventor: Simon Wechsler, Esslingen (DE)

(21) Appl. No.: 19/679,697

(22) Filed: May 17, 2026

(30) Foreign Application Priority Data
May 19, 2025 (DE) 10 2025 119 252.9

(51) Int. Cl. B25F 5/02; A45F 5/02

(52) U.S. Cl. CPC B25F 5/02; A45F 5/021

(57) ABSTRACT

A hand-held power tool includes a main body and a retaining clip. The retaining clip includes a first leg, a second leg, and a connecting element connecting the legs. The first leg is suitable for hanging the hand-held power tool, and the main body has a partially slot-shaped recess that can partially receive the second leg, such that it can be positioned in a fastening position, whereby the retaining clip is fastened in the main body. The leg is formed as an elongated element with an elastic bending element that connects two component elements to each other in a longitudinal direction, such that, in a rest position, they are arranged at an angle less than 180° to each other. The recess is designed such that, upon inserting the second leg and moving it to the fastening position in a fastening direction, it is elastically deformed, such that the angle temporarily increases and it is held in a force-fit and/or form-fit manner.

This application claims priority under 35 U.S.C. § 119 to patent application no. DE 10 2025 119 252.9, filed on May 19, 2025 in Germany, the disclosure of which is incorporated herein by reference in its entirety.

The present disclosure relates to the field of hand-held power tools such as drill drivers and relates to a hand-held power tool with a retaining clip, a corresponding retaining clip, and a suitable main body for such a hand-held power tool.

### BACKGROUND

Electrically driven hand-held power tools, such as cordless drill drivers, are used in various manual tasks. When working with these tools, there is often a need to set the device down for a short period of time. Presently available hand-held, electrically driven tools therefore typically have carrying devices such as belt clips as accessories. However, these are usually fastened to the end of a handle of the electrically driven tool by way of additional fastening elements, such as screws. The assembly and disassembly of such holding devices therefore often requires the use of screw tools and suitable fastening material.

Patent application EP 2 889 108 A2 describes a removable belt buckle fastener for a hand-held, electrically driven tool, comprising a buckle fastener base and a buckle fastener body, the buckle fastener base serving to connect to the belt, while the buckle fastener body serves to connect to the electrically driven tool. Here, the buckle fastener body is matched to the clamping grooves provided on both sides of the housing end of the electrically driven tool.

U.S. 2018/0279752 A1 discloses a belt clip for use with an electric power tool. The power tool includes a tool housing and a battery receptacle. The belt clip includes a body having a first element that has a first portion and a connection portion. The first portion is received in a complementary groove on an inner surface of the battery receptacle, and fastening elements, such as screws, may be used to achieve fastening.

### SUMMARY

According to the disclosure, a hand-held power tool as well as a retaining clip for fastening in a main body of such a hand-held power tool, and a corresponding main body, are proposed.

According to a first aspect of the disclosure, a preferably electrically driven hand-held power tool, such as a hand-held drill driver, a cordless drill driver, or a cordless impact wrench, is disclosed with a main body and a retaining clip. The present disclosure is not limited to battery-driven hand-held power tools, however, but can also be used, for example, for grid-dependent, i.e., grid-powered, hand-held power tools or pneumatically operated hand-held power tools. A retaining clip, also referred to as a retaining clamp, is, in the context of the disclosure, an element for attaching the hand-held power tool to a retaining element, for example a belt, a strap, a loop, a tab, or a waistband of a garment. In the case of a belt as a retaining element, the retaining clip is also referred to as a belt clip. The retaining clip comprises a first leg, a second leg, and a connecting element connecting the first leg and the second leg.

The first leg is suitable for hanging the hand-held power tool in a carrying element. The main body has a first recess having an at least partially slot-shaped course, which can at least partially, preferably completely, receive the second leg, such that the second leg can be positioned in a fastening position, thereby fastening the retaining clip in the main body. In this case, the connecting element can be elastic and preferably has the form of an elastic curvature between the first and second legs, which is designed such that a retaining element, such as a belt, can be clamped between the first leg and the main body of the hand-held power tool. The connecting element may transition abruptly, but also smoothly, into the first and/or the second leg. Preferably, the first leg, the second leg, and/or the connecting element are monolithic. The first leg, the second leg, and/or the connecting element may form a monolithic unit. Preferably, the entire retaining clip comprising the first leg, the second leg, and the connecting element is monolithic. Preferably, the retaining clip is produced in a punch-bending process, for example from sheet metal.

The first recess may pass completely through the main body of the hand-held power tool from a first outer side of the main body to a second outer side of the main body, entirely and preferably transversely to its longitudinal direction. In this case, the first recess can in particular be formed symmetrically with respect to a central axis of the main body. Such a configuration of the first recess allows the second leg to be received through both sides of the first recess. This is particularly advantageous because such a configuration allows the user to attach the retaining clip to either side of the hand-held power tool as needed.

The second leg is configured as a substantially elongated and preferably at least partially flat element comprising an elastic bending element connecting two, preferably flat, component elements of the second leg in a longitudinal direction of the second leg, such that they are arranged at an angle of less than 180° to each other in a rest position outside the main body. The rest position of the second leg is to be understood as a state of the second leg in which no external mechanical forces act on it and, in particular, the elastic bending element is not under tension. Further, a 180° angle corresponds to a straight-line connection of the first and second component elements, i.e., no curvature exists between the first and second component elements. A longitudinal direction in the context of this disclosure is a direction along a longitudinal axis of the second leg. The curvature caused by the elastic bending element in the rest position is consequently perpendicular to the longitudinal axis of the second leg. The elastic bending element may transition abruptly, but also smoothly, into the first and/or the second component element. The first and/or the second component element of the second leg may also be elastic. Like the second leg, the first leg can also be configured as a substantially elongated and preferably at least partially flat element. The first leg is preferably designed to be wider than the second leg and/or has a triangular-like basic shape. The retaining clip, the connecting element, the first leg, and/or the second leg may consist of or comprise a plastic and/or a metal and/or a metal alloy.

The first recess is designed such that, upon insertion of the second leg into the first recess and subsequent movement of the second leg to the fastening position in a fastening direction, the second leg and, typically, the elastic bending element are elastically deformed such that the angle between the two component elements is increased at least temporarily relative to the angle in the rest position, and the second leg is held in the fastening position in the first recess in a force-fit and/or form-fit manner. Also in the fastening position, the angle between the two component elements typically deviates from 180°. For example, the angle may take a value of 160° in the rest position and a greater value, for example 170°, in the fastening position.

In the context of the disclosure, a main body is understood to be a hand-held power tool without the parts intended to be repeatedly attached and removed by a user, such as the retaining clip, an insertion tool, for example a drill bit or screwdriver bit, or a hand-held power tool battery pack (also briefly referred to as a battery). The main body may therefore be different from a housing of the hand-held power tool, for example if the first recess for the retaining clip lies at least partially in a part of the hand-held power tool that is no longer part of the housing. With respect to the orientation of the first leg of the retaining clip with respect to the main body, a variety of embodiments are contemplated. Thus, the first recess and the retaining clip can be designed such that the first leg of the retaining clip is parallel to the main body or deviates only slightly from the main body and points at least approximately in its longitudinal direction, for example in the direction of an insertion tool and/or a drill chuck of the hand-held power tool. It is also conceivable for the retaining clip to point upward, that is, away from a stand base of the power tool. Any other angles are also contemplated depending on the shape of the hand-held power tool.

Preferably, the elastically deformed second leg acts as a spring such that holding in the fastening position is affected by a resulting restoring force and is preferably free of play. In the fastening position, the angle between the two component elements is thus increased relative to the rest position. Holding in the fastening position is thus affected by a frictional engagement. Stated differently, the leading one of the two component elements of the second leg, that is, the component element not positioned toward the first leg, is bent open relative to the other of the two component elements of the second leg upon insertion of the second leg into the first recess, and the angle between the two component elements is increased. This results in a biasing of the second leg in the fastening position, which results in a play-free fit of the second leg in the first recess. The play-free fit of the second leg in the fastening position typically results in a movement-free and noise-free fit of the retaining clip in the main body. Preferably, at least a first wall of the first recess is configured at least in sections, preferably entirely, in a straight line. The second leg can thus be particularly easily moved into the fastening position and is particularly firmly retained there by the restoring force. In the fastening position, the respective outer ends, that is, the ends not connected to the elastic bending element, of the two component elements of the second leg are typically pressed against a region of such a preferably straight first wall of the first recess, while the elastic bending element is pressed against a region of an opposite further wall. Preferably, the further wall is also formed at least in sections, preferably entirely, in a straight line.

Alternatively, however, the first recess can also be designed such that at least one second wall of the first recess has a slope at least in sections, and the second leg, in the fastening position, follows the course of the slope such that holding in the fastening position is affected at least partially by form-fitting engagement and is preferably free of play. The term “slope” is to be understood in the sense of the disclosure such that the second wall faces in a different direction relative to its remaining course and/or to a further wall of the first recess. In particular, such a slope can be initiated by a kink in the course of the second wall. In this case, in the fastening position, the elastic bending element is preferably at the position of the kink in the second wall. In this respect, when considering the course of the second wall, any recesses in the second wall, such as the second recess of the main body described below, are not to be considered.

Preferably, the second leg comprises a latching element connected to the second component element, projecting from the second component element in the rest position and the fastening position, and acting counter to the fastening direction. The latching element and the main body are configured such that, upon reaching the fastening position, the latching element snaps into a second recess of the main body, thereby forming a releasable latching connection. For example, the latching element may be designed as a latching tab, latching cam, latching lug, and/or snap hook, or may comprise such elements. Preferably, the latching element is substantially in the form of a tongue-shaped sheet metal protruding from the remainder of the second leg and is oriented at least partially counter to the fastening direction. In addition to the frictional and/or form-fitting holding of the second leg in the fastening position, the releasable latching connection also serves to secure the second leg in the fastening position in order to hold the second leg even more securely in this fastening position.

Preferably, a wall of the second recess serves in the latching connection as a stop element for the latching element, so that the second leg cannot be moved beyond a certain position counter to the fastening direction.

Preferably, the latching connection is releasable by bending the latching element in a release direction. In this case, the second recess is preferably designed such that bending from the outside can be affected by applying force through the second recess. The release direction typically runs counter to the fastening direction. After releasing the latching connection, the second leg, and thus the retaining clip, can be moved counter to the fastening direction. Bending of the latching element effected from outside the main body means, in particular, pushing down the latching element in the release direction, where “outside” means, in particular, outside the main body.

Preferably, the second component element comprises a third recess that is designed such that the latching element can be received when it is bent through the third recess. This makes the movement radius for the latching element greater than without the third recess, so that the latching element can be moved further out of the position in which it is normally located while the latching connection exists.

Preferably, after positioning the second leg in the fastening position, the retaining clip can be removed from the main body, wherein the removal comprises moving counter to the fastening direction and, if a latching element as described is present, releasing the latching connection.

Preferably, fastening the retaining clip in the main body in the fastening position is achieved solely by a shape of the main body, in particular a housing of the main body, and a shape of the retaining clip. Thus, no further elements need to be provided for fastening purposes, such as screws or similar fastening elements.

Preferably, the main body comprises a housing and/or a handle for holding the handheld power tool, the first recess being partially or entirely arranged in the housing and/or the handle.

Preferably, the first recess comprises a stop, in particular a protrusion, and the second leg is configured such that, due to the stop, the second leg is not movable beyond the fastening position in the fastening direction.

It is further contemplated that the main body of the hand-held power tool may have several, for example two, three, or four first recesses as described in the preceding text, which serve to at least partially receive and secure the second leg without play and thus the retaining clip, and are located at different positions of the main body, for example on different sides and/or regions of the main body. This allows a user of the hand-held power tool to attach the retaining clip flexibly in a position that is particularly advantageous for the respective activity. By designing the retaining clip and the first recesses accordingly, it is possible to provide different orientations of the retaining clip relative to the same main body for different first recesses, for example to define different angles between the retaining clip and a longitudinal direction of the main body as a function of the respective first recess. By the different orientations of the retaining clip in relation to the main body thus achieved for the various provided positions, it can be ensured that, in all positions, stable holding of the hand-held power tool on the respectively used retaining element is ensured. All of these different first recesses may extend completely through the main body of the hand-held power tool from a first outer side of the main body to a second outer side of the main body and preferably transverse to its longitudinal direction, and are preferably configured symmetrically with respect to a central axis of the main body, to allow two-sided attachment of the retaining clip. In order to enable two-sided fastening of the retaining clip, two separate first recesses can alternatively be provided at corresponding positions on opposite sides of the main body.

According to a second aspect of the disclosure, a retaining clip is proposed for fastening in a main body of a power tool, such as a hand-held drill driver, a cordless drill driver, or a cordless impact driver, preferably as described above. Here, the retaining clip comprises a first leg, a second leg, and a connecting element connecting the first leg and the second leg. The first leg is suitable for hanging the hand-held power tool in a carrying element and the main body has a first recess having an at least partially slot-shaped course, which can at least partially receive the second leg, such that the second leg can be positioned in a fastening position, thereby fastening the retaining clip in the main body. In this case, the connecting element can be elastic and preferably has the form of an elastic curvature between the first and second legs, which is designed such that a retaining element can be clamped between the first leg and the main body of the hand-held power tool.

In this case, the second leg is configured as a substantially elongated and preferably at least partially flat element comprising an elastic bending element that connects two component elements to each other in a longitudinal direction of the second leg such that they are arranged at an angle of less than 180° to each other in a rest position outside the main body.

In this case, the first recess is designed such that, upon insertion of the second leg into the first recess and subsequent movement of the second leg to the fastening position in a fastening direction, the second leg is elastically deformed such that the angle between the two component elements is increased at least temporarily, and the second leg is held in the fastening position in the first recess in a force-fit and/or form-fit manner.

For further possible configurations of the main body and the cooperation with a suitable retaining clip, reference is made to the embodiments of a hand-held power tool according to the disclosure according to the first aspect of the disclosure, which can be adopted accordingly.

Finally, according to a third aspect, a main body for a hand-held power tool, such as a hand-held drill driver, a cordless drill driver, or a cordless impact driver, preferably as described above, is proposed, wherein the hand-held power tool comprises a retaining clip, preferably as described above. In this case, the retaining clip has a first leg, a second leg and a connecting element connecting the first leg and the second leg to each other, wherein the first leg is suitable for hanging the hand-held power tool in a carrying element and the main body has a first recess having an at least partially slot-shaped course, which can at least partially receive the second leg, such that the second leg can be positioned in a fastening position, thereby fastening the retaining clip on the main body.

In this case, the second leg is configured as a substantially elongated element comprising an elastic bending element that connects two component elements to each other in a longitudinal direction of the second leg such that they are arranged at an angle of less than 180° to each other in a rest position outside the main body.

In this case, the first recess is designed such that, upon insertion of the second leg into the first recess and subsequent movement of the second leg to the fastening position in a fastening direction, the second leg is elastically deformed such that the angle between the two component elements is increased at least temporarily, and the second leg is held in the fastening position in the first recess in a force-fit and/or form-fit manner.

For further possible configurations of the retaining clip and the cooperation with a suitable main body, reference is made to the embodiments of a hand-held power tool according to the first aspect of the disclosure and the retaining clip according to the second aspect of the disclosure, which can be adopted accordingly.

The present disclosure provides an elegant way to design a hand-held power tool with a retaining clip. In particular, the disclosure allows for a fixed and free-of-play fit of the retaining clip in a first recess of the main body of a hand-held power tool without the need for complex mechanics. Tools and/or additional fastening material such as screws and the like may also be dispensed with for attachment. This allows for quick removal of the retaining clip by a user.

By way of a symmetrical design of the first recess extending completely through the main body of the hand-held power tool in the lateral direction, the hand-held power tool can further be designed such that attachment of the retaining clip on both sides is enabled. Likewise, suitable first recesses for a retaining clip according to the disclosure can be provided at multiple positions of a main body of a hand-held power tool according to the disclosure, which can also be designed in such a way that the retaining clip is oriented differently for various first recesses and, in particular, optimized with regard to the retaining function. These aspects allow a user a high degree of flexibility in attaching the retaining clip.

### BRIEF DESCRIPTION OF THE DRAWINGS

Embodiments of the disclosure are described in greater detail hereinafter with reference to the drawings and the subsequent description.

It shows:

FIG. 1A is a side view of an exemplary hand-held power tool according to the disclosure in schematic form;

FIG. 1B is a further side view of the exemplary hand-held power tool according to the disclosure in schematic form;

FIG. 2 is a detail view of a portion of the exemplary hand-held power tool in a first alternative in a top sectional view;

FIG. 3 shows a detail view of the same portion of the exemplary hand-held power tool in the first alternative in a sectional view from the rear; and

FIG. 4 is a detail view of a portion of the exemplary hand-held power tool in a second alternative in a top sectional view.

### DETAILED DESCRIPTION

In the following description of the embodiments of the disclosure, identical or similar elements are denoted by identical reference signs, whereby a repeated description of these elements is omitted in individual cases. The drawings show the subject matter of the disclosure only schematically.

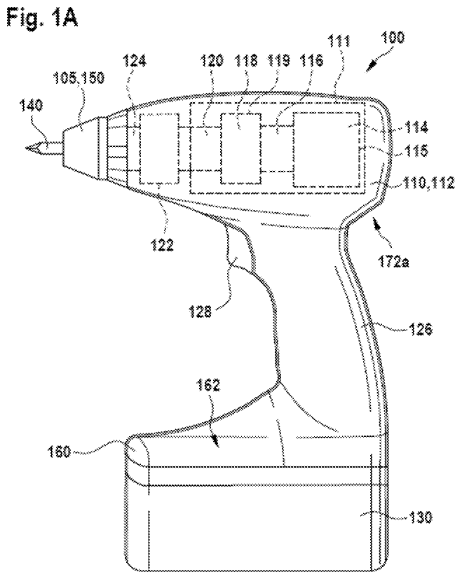

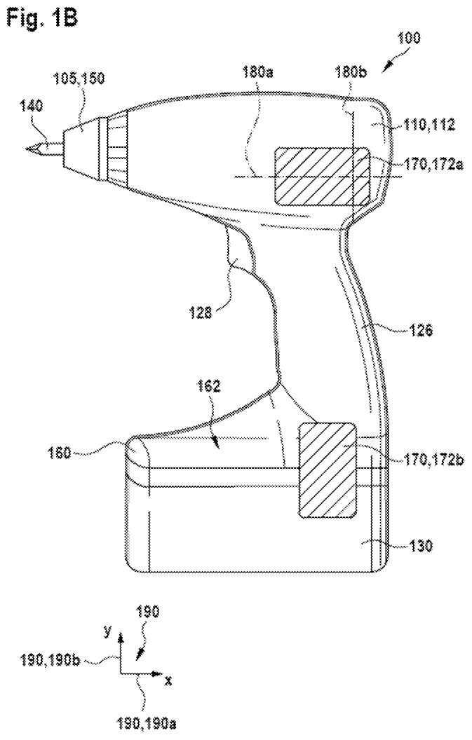

FIG. 1A shows a hand-held power tool 100 according to the disclosure, wherein it is configured here as a cordless impact screwdriver, for example. The hand-held power tool 100 comprises a tool holder 105 and an exemplary percussion mechanism 122, such as a rotary or rotational percussion mechanism. The hand-held power tool 100 comprises a main body 110 with a housing 112. To provide a power supply that is independent of the electric grid, the handheld power tool 100 may be mechanically and electrically connected to a power supply for cordless operation, so that the hand-held power tool 100 is configured as a cordless hand-held power tool 100. A hand-held power tool rechargeable battery pack 130 is used here as the power supply.

The main body 110 comprises a drive unit 111 and the percussion mechanism 122, as shown schematically. The drive unit 111 further comprises an electric drive motor 114, which is supplied with current by the hand-held power tool battery pack 130, and a transmission 118. The gearbox 118 can be designed as at least one shiftable gearbox. The drive motor 114 is designed such that it may be actuated, for example via a manual switch 128, so that the drive motor 114 may be switched on and off. The drive motor 114 can be any type of motor, e.g. an electronically commutated motor or a DC motor. The drive motor 114 may advantageously be electronically controlled and/or regulated, so that a reversing mode and a desired rotational speed may be implemented. The design and mode of operation of a suitable drive motor are sufficiently well-known to those skilled in the art, which is why they will not be discussed in more detail here.

The gearbox 118 is connected to the drive motor 114 via a motor shaft 116. The transmission 118 is provided to convert a rotation of the motor shaft 116 into a rotation between the transmission 118 and the impact mechanism 122 via a drive element 120, for example a drive shaft. Preferably, this conversion takes place such that the drive element 120 rotates relative to the motor shaft 116 with increased torque, but at a reduced rotational speed.

A motor housing 115 is, by way of illustration, associated with the drive motor 114. Similarly, a transmission housing 119 is associated with the transmission 118. Both the motor housing 115 and the transmission housing 119 are, by way of example, arranged inside the housing 112. However, it is also conceivable that the drive motor 114 and the transmission 118 can be arranged directly in the housing 112 if the hand-held power tool 100 is designed in an “open frame” design.

The impact mechanism 122 is connected to the drive element 120 and comprises, by way of example, an impact body 125, which generates impact-like rotary pulses at a high intensity. These impact-like rotary pulses are transmitted to an output shaft 124, for example a work spindle, via the percussion body 125. The percussion mechanism 122 comprises a percussion mechanism housing not shown in more detail here, but can also be arranged in another suitable housing, such as the gear housing 119 or housing 112.

The example impact mechanism 122 is designed to drive the output shaft 124. An output shaft 124 is associated with a tool holder 105, formed as a chuck 150, which is provided to receive an insertion tool 140. The tool holder 105 is preferably molded onto and/or designed on the output shaft 124. The tool holder 105 is formed, for example, in the manner of a bit holder and is provided to receive insertion tools in the manner of a screwdriver bit. The type of the screwdriver bit, for example HEX type, is sufficiently well-known to those skilled in the art. The present disclosure is not limited to the use of HEX screwdriver bits, however; other tool holders that appear useful to the those skilled in the art, such as HEX drills, SDS quick-insert tools or round-shank drill chucks, can be used as well. The design and functioning of a suitable bit holder are sufficiently well-known to those skilled in the art as well.

The main body 110 further comprises the drive unit 111 and the hand switch 128. The main body 110 also comprises a power supply holding device 160. The power supply holding device 160 accommodates the hand-held power tool rechargeable battery pack 130 and forms a base 162 comprising a standing surface. The hand-held power tool rechargeable battery pack 130 may be released from the power supply holding device 160 without tools. The housing 112 also comprises a handle 126. The handle 126 can be grasped by a user of the hand-held power tool 100.

The hand-held power tool 100 includes a retaining clip 170 (not shown in FIG. 1A) that serves to hang the hand-held power tool 100 on a supporting element such as a belt. In FIG. 1A, a position 172a for such a retaining clip 170 is indicated, which is held in a first recess 230 (not shown in FIG. 1A), but the disclosure is not limited to this position 172a.

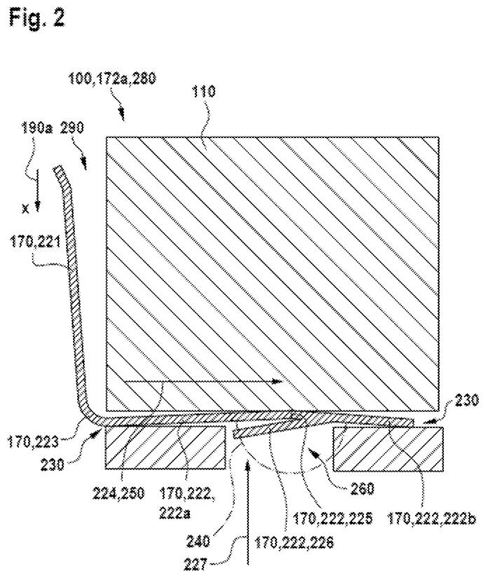

FIG. 1B shows the hand-held power tool 100 according to the disclosure from FIG. 1A, wherein, for better clarity, some elements from FIG. 1A were omitted for FIG. 1B and the retaining clip 170 was instead shown visibly at the position 172a. As already mentioned, the disclosure is not limited to this position 172a of the retaining clip 170. In FIG. 1B, therefore, a further possible position 172b for the retaining clip 170 is also shown, namely in the base 162. The main body 110 of the hand-held power tool 100 may also be configured such that multiple positions 172a, 172b are present adjacent to one another so that a corresponding retaining clip 170 can be flexibly attached by a user of the hand-held power tool 100. To better understand the following FIGS. 2 to 4, a coordinate system 190 is also shown with an x-axis 190a in the horizontal direction and a y-axis 190b in the vertical direction.

FIG. 2 now shows the exemplary hand-held power tool 100 of FIGS. 1A and 1B according to the disclosure in a first alternative in a schematic and partial sectional view along a plane located in the hand-held power tool 100. The associated section line is identified in FIG. 1B by a dashed line 180a, so FIG. 2 shows an area around position 172a. To illustrate the orientation, the x-axis 190a from FIG. 1B is shown again in FIG. 2.

The retaining clip 170 comprises a first leg 221, a second leg 222, and a connecting element 223 connecting the first leg 221 and the second leg 222 to each other. Here, the first leg 221 and the second leg 222 are designed as substantially elongated elements. The second leg 222 has an elastic bending element 225 that connects two component elements 222a, 222b of the second leg 222 to each other in a longitudinal direction 224 of the second leg 222 such that, in a rest position assumed outside the main body 110, they are arranged relative to each other at an angle 240 of less than 180°. For ease of illustration, the elastic bending element 225 is shown in this and the following figures as a single line, with this dimensioning to be understood as purely exemplary. The elastic bending element 225 is not limited to such a narrow variant, but typically has a greater extent relative to the longitudinal direction 224 of the second leg 222. The line further generally indicates an approximate typical location of the elastic bending element 225 and an approximate possible position of the greatest curvature of the second leg 222 in the region of the elastic bending element 225.

The first leg 221 of the retaining clip 170 serves to hook the hand-held power tool 100 onto a carrying element such as a belt, wherein the carrying element is positioned for this purpose between the first leg 221 and the main body 110, i.e., in FIG. 2 in the region 290. The main body 110 has a first recess 230 with a partially slot-like and straight course that, in the example shown in FIG. 2, extends across the entire main body 110. Due to the symmetry of the first recess 230, this allows attachment of the retaining clip 170 on either side. The second leg 222 of the retaining clip 170 is in FIG. 2 in a fastening position 280 in which the retaining clip 170 is secured in the main body 110.

Upon insertion of the second leg 222 into the first recess 230 and subsequent movement of the second leg 222 to the fastening position 280 in a fastening direction 250 by a user, the second leg 222 is elastically deformed such that the angle 240 between the two component elements 222a, 222b is increased compared with the rest position of the retaining clip 170, and the second leg 222 is held in the fastening position 280 in the first recess 230 in a force-fit manner. This is achieved by the elastically deformed second leg 222 acting as a spring and the ends of the two component elements 222a, 222b being pressed against a region of a first wall of the first recess 230, while the elastic bending element 225 is pressed against a region of an opposing further wall. Holding in this fastening position 280 is thus provided by a resulting restoring force of the spring. As a result, the second leg 222 and thus the retaining clip 170 are held without play.

In the example shown in FIG. 2, the second leg 222 comprises a latching element 226 connected to the second component element 222b, projecting from the second component element 222b in the rest position and the fastening position 280 and oriented opposite the fastening direction 250. This latching element 226 and the main body 110 are configured such that the latching element 226 snaps into a second recess 260 of the main body 110 upon reaching the illustrated fastening position 280. A releasable latching connection is thereby formed.

The latching connection is releasable by bending the latching element 226 in a release direction 227, in the example shown in the direction of the second leg 222. The second recess 260 is designed such that bending from the outside, i.e., from outside the main body 110, can be affected by applying force through the second recess 260.

After positioning the second leg 222 in the fastening position 280, the retaining clip 170 is connected to the hand-held power tool 100 without play. To remove the retaining clip 170, the second leg 222 must be moved out of the fastening position 280 again, opposite the fastening direction 250. To do this, the latching connection must first be released. For this purpose, in the exemplary hand-held power tool 100 shown in FIG. 2, to release the retaining clip 170, a user must first press the latching element 226 in the release direction 227 through the second recess 260, so that the latching element 226 no longer blocks movement opposite the fastening direction 250.

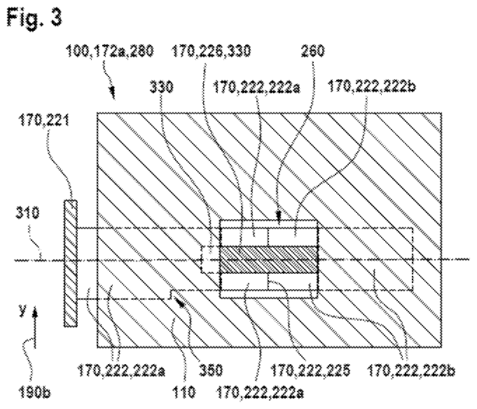

FIG. 3 once again illustrates the exemplary hand-held power tool 100 according to the disclosure of FIGS. 1A and 1B in the first alternative of FIG. 2, in a further schematic and partial sectional view, this time along a plane lying in the hand-held power tool 100 as viewed from the rear, i.e., opposite the direction of the x-axis 190a, wherein an area around position 172a is again shown. The associated section line is indicated by a dashed line 180b in FIG. 1B. In FIG. 3, in turn, a line 310 is drawn that indicates the position of the plane shown in FIG. 2. To further illustrate the orientation, the y-axis 190b from FIG. 1B is shown again in FIG. 3. The first leg 221 of the retaining clip 170 shown in FIG. 3 is configured to be wider than the second leg 222 to improve retention on a retaining element. However, this embodiment is only exemplary. The first leg 221 can be formed in a variety of shapes and is by no means limited to the variants shown in the figures.

As shown in FIG. 3, the second component element 222b of the second leg 222 may have a third recess 330, which is designed such that the latching element 226 can be received in this third recess 330 when it is bent to release the retaining clip 170. The latching element 226, visible through the second recess 260 in FIG. 3 and shown dashed, covers this third recess 330 in the drawing. Furthermore, the first recess 230 may have a stop 350, as shown by way of example in FIG. 3, in particular a projection, and the second leg 222 may be configured such that, due to the stop 350, the second leg 222 cannot be moved beyond the fastening position 280 in the fastening direction 250.

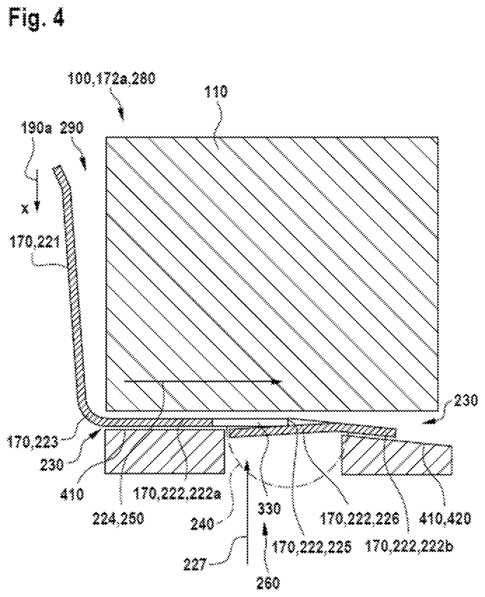

FIG. 4 now shows, in an identical representation to FIG. 2, an alternative to the fastening mechanism shown therein that is also according to the disclosure: In the variant shown in FIG. 4, the second leg is held by a suitable course of the second leg 222 in cooperation with a corresponding shape of the first recess 230. A second wall 410 of the first recess 230 corresponds in terms of its position to the first wall from the embodiment of FIG. 2, but in contrast thereto does not have a continuously straight course; rather, in one region it has a slope 420 relative to the remaining course of the second wall 410. This slope 420 is matched to the second leg 222 of the retaining clip 170 in the fastening position 280 such that it at least partially follows the course of the second wall 410 in the region of the slope 420. As a result, the holding in the fastening position 280 is affected by a form fit and is preferably free of play. As in the embodiment of FIG. 3, a third recess 330 in the second leg 222, shown in white, ensures that the latching element 226 can be received by the third recess 330 during bending to release the retaining clip 170, and thus a greater radius of movement is realized for the latching element 226. FIG. 3, as for FIG. 2, also shows a corresponding sectional view for the variant of FIG. 4; the representations from this perspective do not differ for the two variants of FIGS. 2 and 3.

Both variants shown in the figures, that is, FIGS. 2 and 3 for the first variant and FIG. 4 for the second variant, have in common that fastening the retaining clip 170 in the main body 110 in the fastening position 280 is achieved solely by a shape of the main body 110, for example a housing 112 of the main body 110, and a shape of the retaining clip 170. No further fastening elements, such as screws, are required to fasten the retaining clip 170. In contrast to the variant of FIGS. 2 and 3, however, in the embodiment shown in FIG. 4, due to the different shape of the first recess 230 and the associated lack of symmetry, it is not possible to attach the retaining clip 170 on both sides.

The disclosure is not limited to the exemplary embodiments described herein and the aspects highlighted thereby. Rather, within the range specified by the claims, a plurality of modifications is possible, which lie within the abilities of a person skilled in the art.

What is claimed is:

1. A hand-held power tool, comprising:
a main body; and
a retaining clip that includes a first leg, a second leg, and a connecting element that connects the first leg and the second leg to each other,
wherein the first leg is configured for hanging the hand-held power tool in a carrying element, and the main body has a first recess having an at least partially slot-shaped course, which is configured to at least partially receive the second leg, such that the second leg is positioned in a fastening position, thereby fastening the retaining clip in the main body,
wherein the second leg is formed as a substantially elongated element including an elastic bending element that connects two component elements of the second leg to each other in a longitudinal direction of the second leg, such that, in a rest position outside the main body, they are arranged at an angle of less than 180° to each other, and
wherein the first recess is designed such that, when the second leg is inserted into the first recess and the second leg is subsequently moved to the fastening position in a fastening direction, the second leg is elastically deformed such that the angle between the two component elements increases at least temporarily and the second leg is held in the fastening position in the first recess in a force-fit and/or form-fit manner.

2. The hand-held power tool according to claim 1, wherein the elastically deformed second leg acts as a spring, such that holding in the fastening position is affected by a resulting restoring force.

3. The hand-held power tool according to claim 1, wherein at least a second wall of the first recess has a slope at least in sections, and the second leg in the fastening position follows the course of the slope, such that holding in the fastening position is affected at least partially by a form fit.

4. The hand-held power tool according to claim 1, wherein the second leg includes a latching element connected to the second component element and, in the rest position and the fastening position, projects from the second component element and acts counter to the fastening direction, and wherein the latching element and the main body are designed such that, upon reaching the fastening position, the latching element latches into a second recess of the main body, thereby forming a releasable latching connection.

5. The hand-held power tool according to claim 4, wherein the latching connection is releasable by bending the latching element in a release direction.

6. The hand-held power tool according to claim 5, wherein the second component element has a third recess configured such that the latching element is receivable during bending through the third recess.

7. The hand-held power tool according to claim 1, wherein:
the retaining clip is configured to be removable from the main body after positioning the second leg in the fastening position, and
the removal includes moving opposite the fastening direction.

8. The hand-held power tool according to claim 1, wherein fastening the retaining clip in the main body in the fastening position is achieved solely by a shape of the main body, and a shape of the retaining clip.

9. The hand-held power tool according to claim 1, wherein the main body includes a housing and/or a handle configured to hold the hand-held power tool, the first recess being partially or entirely arranged in the housing and/or the handle.

10. The hand-held power tool according to claim 1, wherein the first recess includes a stop, and the second leg is configured such that, due to the stop, the second leg is not movable beyond the fastening position in the fastening direction.

11. A retaining clip for fastening in a main body of the hand-held power tool according to claim 1, wherein:
the retaining clip comprises a first leg, a second leg, and a connecting element connecting the first leg and the second leg to each other,
wherein the first leg is configured for hanging the hand-held power tool in a carrying element, and the main body has a first recess having an at least partially slot-shaped course, which is configured to at least partially receive the second leg, such that the second leg can be positioned in a fastening position, thereby fastening the retaining clip in the main body,
wherein the second leg is formed as a substantially elongated element including an elastic bending element that connects two component elements of the second leg to each other in a longitudinal direction of the second leg, such that, in a rest position outside the main body, they are arranged at an angle of less than 180° to each other, and
wherein the first recess is designed such that, when the second leg is inserted into the first recess and the second leg is subsequently moved to the fastening position in a fastening direction, the second leg is elastically deformed such that the angle between the two component elements increases at least temporarily and the second leg is held in the fastening position in the first recess in a force-fit and/or form-fit manner.

12. A main body for the hand-held power tool according to claim 1, wherein:
the hand-held power tool has a retaining clip and the retaining clip comprises a first leg, a second leg, and a connecting element connecting the first leg and the second leg to each other,
wherein the first leg is configured for hanging the hand-held power tool in a carrying element, and the main body has a first recess having an at least partially slot-shaped course, which is configured to at least partially receive the second leg, such that the second leg can be positioned in a fastening position, thereby fastening the retaining clip onto the main body,
wherein the second leg is formed as a substantially elongated element including an elastic bending element that connects two component elements of the second leg to each other in a longitudinal direction of the second leg, such that, in a rest position outside the main body, they are arranged at an angle of less than 180° to each other, and
wherein the first recess is designed such that, when the second leg is inserted into the first recess and the second leg is subsequently moved to the fastening position in a fastening direction, the second leg is elastically deformed such that the angle between the two component elements increases at least temporarily and the second leg is held in the fastening position in the first recess in a force-fit and/or form-fit manner.

13. The hand-held power tool according to claim 1, wherein the hand-held power tool is a hand-held electric tool.

14. The hand-held power tool according to claim 1, wherein:
the elastically deformed second leg acts as a spring, such that holding in the fastening position is affected by a resulting restoring force and is free of play, and
at least a first wall of the first recess has a straight course at least in sections.

15. The hand-held power tool according to claim 1, wherein at least a second wall of the first recess has a slope at least in sections, and the second leg in the fastening position follows the course of the slope, such that holding in the fastening position is affected at least partially by a form fit and is free of play.

16. The hand-held power tool according to claim 5, wherein the second recess is designed such that the bending can be affected from the outside by application of force through the second recess.

17. The hand-held power tool according to claim 1, wherein fastening the retaining clip in the main body in the fastening position is achieved solely by a shape of a housing of the main body, and a shape of the retaining clip.

18. The hand-held power tool according to claim 10, wherein the stop is configured as a protrusion.
